(19) United States
(12) Patent Application Publication
(10) Pub. No.: US 2025/0256928 A1
(43) Pub. Date: Aug. 14, 2025

(54) POWDER FEEDING DEVICE AND POWDER TRANSFER METHOD

(71) Applicant: SK ON CO., LTD., Seoul (KR)

(72) Inventor: Yeong Jun JI, Daejeon (KR)

(21) Appl. No.: 19/024,339

(22) Filed: Jan. 16, 2025

(30) Foreign Application Priority Data
Feb. 8, 2024 (KR) 10-2024-0019593

(51) Int. Cl. B65G 53/24; B65G 53/36; B65G 53/50; B65G 53/66

(52) U.S. Cl. CPC B65G 53/24; B65G 53/36; B65G 53/50; B65G 53/66; B65G 2201/042; B65G 2203/042; B65G 2812/1625; B65G 2812/1691

(57) ABSTRACT

Powder feeding device and powder transfer method are disclosed. The powder feeding device includes a container including a container body forming a storage space therein; a hopper including a hopper body forming an accommodation space therein; a chamber unit including a chamber housing forming a hollow portion and coupled to the hopper body; a pipe assembly including a container pipe unit which extends from the container and is opened or closed, a hopper pipe unit which is branched from the container pipe unit, is connected to the hopper body, and is opened or closed, and a chamber pipe unit which is branched from the container pipe unit, is connected to the chamber housing, and is opened or closed; and a valve assembly including a coupling valve which is coupled to at least one of the chamber housing and the hopper body and connects/disconnects the storage space to/from the hollow portion.

### CROSS-REFERENCE TO RELATED APPLICATION AND CLAIM OF PRIORITY

This application claims priority to Korean Patent Application No. 10-2024-0019593 filed on Feb. 8, 2024 in the Korean Intellectual Property Office (KIPO), the entire disclosure of which is incorporated by reference herein.

### TECHNICAL FIELD

Embodiments of the disclosure relate to a powder feeding device and a powder transfer method.

### BACKGROUND

For powder used in secondary batteries, etc., accurate weighing may be important. In addition, there is a need to increase process efficiency by quickly transferring the powder. A device and method capable of accurately and quickly transferring the powder are required.

### SUMMARY

An object of embodiments of the disclosure is to provide a powder feeding device and a powder transfer method that vary a transfer mode based on an amount of transferred powder.

A powder feeding device according to an embodiment of the disclosure may comprise a container including a container body forming a storage space inside the container body; a hopper including a hopper body forming an accommodation space inside the hopper body; a chamber unit including a chamber housing, the chamber housing forming a hollow portion and coupled to the hopper body; a pipe assembly including a container pipe unit which extends from the container and is opened or closed, a hopper pipe unit which is branched from the container pipe unit, is connected to the hopper body, and is opened or closed, and a chamber pipe unit which is branched from the container pipe unit, is connected to the chamber housing, and is opened or closed; and a valve assembly including a coupling valve which is coupled to at least one of the chamber housing and the hopper body and connects or disconnects the storage space with the hollow portion.

The valve assembly may further include a container valve which is coupled to the container pipe unit and opens or closes the container pipe unit, a hopper valve which is coupled to the hopper pipe unit and opens or closes the hopper pipe unit, and a chamber valve which is coupled to the chamber pipe unit and opens or closes the chamber pipe unit.

The chamber unit may further include a chamber port extending from the chamber housing. The pipe assembly may further include a pump pipe, and an end of the pump pipe extends from the chamber port and another end of the pump pipe leads to a vacuum pump.

The valve assembly may further include a vacuum line valve which is coupled to the pump pipe and opens or closes the pump pipe.

The valve assembly may further include a vacuum release valve which is coupled to the chamber port and opens or closes the chamber port.

The end of the pump pipe may be located between the vacuum release valve and the chamber housing.

The chamber unit may further include a chamber filter which is located in the hollow portion of the chamber housing and performs a filter function.

The chamber unit may further include a chamber blower spraying a gas into the chamber filter.

The powder feeding device may further comprise a pressure sensor measuring an internal atmospheric pressure of the chamber housing, and a control unit connected to the pressure sensor and receiving a second signal from the pressure sensor. The control unit may operate the chamber blower when the internal atmospheric pressure of the chamber housing from the second signal is greater than or equal to a reference chamber internal pressure.

The powder feeding device may further comprise a vacuum pump and a vacuum filter unit. The pipe assembly may further include a pump pipe, and an end of the pump pipe extends from the chamber unit and another end of the pump pipe leads to the vacuum pump. The vacuum filter unit may include a vacuum filter housing coupled to the pump pipe, and a vacuum filter located in the vacuum filter housing.

The powder feeding device may further comprise a weight sensor connected to the hopper body and measuring a weight applied to the weight sensor, and a control unit connected to the weight sensor and receiving a second signal from the weight sensor. The control unit may open the container pipe unit and the hopper pipe unit and close the chamber pipe unit when an increase amount of a weight measured by the weight sensor from the second signal is less than or equal to a first reference powder amount.

The control unit may open the container pipe unit and the chamber pipe unit and close the hopper pipe unit when the increase amount of the weight from the second signal is greater than or equal to the first reference powder amount and is less than a second reference powder amount.

A powder transfer method of transferring a powder stored in a container to one of a hopper and a chamber unit may comprise measuring an internal pressure of a chamber housing included in the chamber unit; comparing the measured internal pressure with a reference chamber internal pressure; and spraying a gas into a chamber filter included in the chamber housing when the measured internal pressure is greater than or equal to the reference chamber internal pressure, or transferring the powder stored in the container to one of the hopper and the chamber unit when the measured internal pressure is less than the reference chamber internal pressure. Transferring the powder may be performed in parallel with measuring the internal pressure.

Spraying the gas into the chamber filter may comprise determining whether a transfer mode is a first transfer mode, performing a first blowing mode when the transfer mode is the first transfer mode, and performing a second blowing mode when the transfer mode is not the first transfer mode.

When an amount of the powder introduced into the hopper and the chamber unit is less than a first reference powder amount, the transfer mode may be the first transfer mode. When the amount of the powder introduced into the hopper and the chamber unit is greater than or equal to the first reference powder amount and is less than a second reference powder amount, the transfer mode may be a second transfer mode.

Performing the first blowing mode may comprise performing a first pre-blowing process of blocking the hopper and the container from communicating with the chamber housing and exposing the chamber housing to an outside air, spraying the gas into the chamber filter, and performing a first post-blowing process of blocking the chamber housing from the outside air and communicating the chamber housing with the hopper and the container.

Performing the second blowing mode may comprise performing a second pre-blowing process of blocking the hopper and the container from communicating with the chamber housing and exposing the chamber housing to an outside air, spraying the gas into the chamber filter, and performing a second post-blowing process of blocking the chamber housing from the outside air and communicating the chamber housing with the container.

Transferring the powder may comprise measuring an amount of the powder introduced into the hopper and the chamber unit, comparing the measured amount of the powder with a first reference powder amount, and performing a first transfer mode when the measured amount of the powder is less than the first reference powder amount.

Transferring the powder may comprise comparing the measured amount of the powder with a second reference powder amount when the measured amount of the powder is greater than or equal to the first reference powder amount, and performing a second transfer mode when the measured amount of the powder is less than the second reference powder amount. In performing the first transfer mode, the powder stored in the container may be transferred to the hopper. In performing the second transfer mode, the powder stored in the container may be transferred to the chamber housing,

Performing the first transfer mode may be performed in parallel with measuring the amount of the powder, and performing the second transfer mode may be performed in parallel with measuring the amount of the powder.

According to an embodiment of the disclosure, a powder feeding device and a powder transfer method that vary a transfer mode based on an amount of transferred powder can be provided.

A powder feeding device and a powder transfer method according to some embodiments of the disclosure can be used in eco-friendly electric vehicles, hybrid vehicles, etc. to prevent climate change by suppressing air pollution and greenhouse gas emissions.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIG. 1 illustrates a powder feeding device according to an embodiment of the disclosure.

FIG. 2 illustrates a cut-away view of a part of a hopper illustrated in FIG. 1.

FIG. 3 is a block diagram of a powder feeding device according to an embodiment of the disclosure.

FIG. 4 is a flow chart illustrating a powder transfer method according to an embodiment of the disclosure.

FIG. 5 is a flowchart illustrating a filter blowing step.

FIG. 6 is a flowchart illustrating a step of performing a first blowing mode.

FIG. 7 is a flowchart illustrating a step of performing a second blowing mode.

FIG. 8 is a flowchart illustrating a powder transfer step.

### DETAILED DESCRIPTION OF THE EMBODIMENTS

Reference will now be made in detail to embodiments of the disclosure, examples of which are illustrated in the accompanying drawings. However, the following description is merely an example and does not intend to limit the disclosure to a specific implementation.

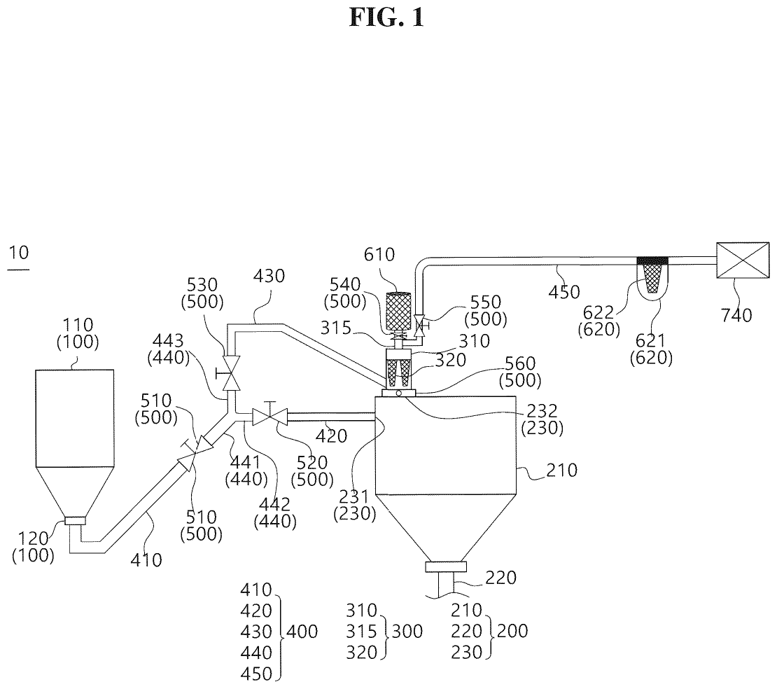

FIG. 1 illustrates a powder feeding device according to an embodiment of the disclosure. A powder feeding device 10 may be schematically illustrated in FIG. 1.

Referring to FIG. 1, the powder feeding device 10 may include a container 100. The container 100 may include a container body 110. The container body 110 may form a storage space therein.

For example, the container body 110 may accommodate powder. For example, the powder may be located in the storage space formed in the container body 110.

The powder accommodated in the container body 110 may be, for example, a component of a secondary battery. For example, the powder accommodated in the container body 110 may be a material forming an active material of the secondary battery.

The container 100 may include a container outlet 120. The container outlet 120 may be formed, coupled, or connected to the container body 110.

For example, the container outlet 120 may extend from an end of the container body 110. For example, the container outlet 120 may extend downward from a lower end of the container body 110.

The container outlet 120 may communicate with the container body 110. For example, the powder contained in the container body 110 may be discharged to the outside of the container 100 through the container outlet 120.

The powder feeding device 10 may include a pipe assembly 400. The pipe assembly 400 may include a container pipe 410. The container pipe 410 may form a shape of a pipe or a tube.

The container pipe 410 may be connected or coupled to the container 100. For example, the container pipe 410 may be connected or coupled to the container outlet 120. For example, the container pipe 410 may connect the container outlet 120 to a container valve 510.

For example, the container pipe 410 may communicate with the container outlet 120. For example, at least a portion of the powder accommodated in the container body 110 may be transferred to the container pipe 410 via the container outlet 120.

The powder feeding device 10 may include a hopper 200. The hopper 200 may include a hopper body 210. The hopper body 210 may form an accommodation space therein. For example, at least a portion of the powder located in the container pipe 410 may be transferred and located in the accommodation space formed in the hopper body 210.

The hopper 200 may include a hopper inlet 230. The hopper inlet 230 may be formed, connected, or coupled to the hopper body 210. For example, the hopper inlet 230 may be connected to or communicate with the accommodation space formed in the hopper body 210. For example, the hopper inlet 230 may be located at the upper end of the hopper body 210.

A plurality of hopper inlets 230 may be provided. For example, the hopper 200 may include a plurality of hopper inlets 230. For example, the hopper 200 may include a hopper pipe inlet 231 and a hopper chamber inlet 232. The hopper inlet 230 may include or indicate at least one of the hopper pipe inlet 231 and the hopper chamber inlet 232.

For example, the hopper pipe inlet 231 may be located at an upper end of a side of the hopper body 210. For example, the hopper chamber inlet 232 may be located on a top face of the hopper body 210. The hopper inlet 230 may be located above a hopper outlet 220.

The hopper inlet 230 may be connected or coupled to the pipe assembly 400. For example, the hopper pipe inlet 231 may be connected or coupled to a hopper pipe 420. For example, the hopper chamber inlet 232 may be connected or coupled to a coupling valve 560.

The hopper 200 may include the hopper outlet 220. The hopper outlet 220 may be connected or coupled to the hopper body 210. For example, the hopper outlet 220 may be connected or coupled to a lower end of the hopper body 210.

For example, the hopper outlet 220 may form a shape extending downward from the lower end of the hopper body 210. At least a portion of the powder contained in the hopper body 210 may pass through the hopper outlet 220 and be discharged to the outside of the hopper 200.

The powder feeding device 10 may include a chamber unit 300. The chamber unit 300 may include a chamber housing 310. The chamber housing 310 may be connected or coupled to the hopper body 210. For example, the chamber housing 310 may be connected to the hopper body 210 through the coupling valve 560.

The chamber housing 310 may be located above the hopper body 210. For example, the coupling valve 560 may be located, connected, or coupled to the hopper chamber inlet 232, and the chamber housing 310 may be connected or coupled to the coupling valve 560.

The chamber housing 310 may form a hollow portion. A size of the hollow portion formed in the chamber housing 310 may be less than a size of the accommodation space formed in the hopper body 210.

An internal pressure of the chamber housing 310 may be controlled. For example, the internal pressure (or atmospheric pressure) of the chamber housing 310 may be maintained lower than an external pressure of the chamber housing 310. For example, the internal pressure (or atmospheric pressure) of the chamber housing 310 may be maintained lower than an internal pressure (or atmospheric pressure) of the container body 110.

The chamber unit 300 may include a chamber port 315. The chamber port 315 may be connected or coupled to the chamber housing 310. For example, the chamber port 315 may form a shape extending from the chamber housing 310. For example, the chamber port 315 may be formed integrally with the chamber housing 310.

A hollow portion may be formed inside the chamber port 315. For example, the chamber port 315 may form a shape of a cylinder bore. For example, the hollow portion formed in the chamber port 315 may communicate with the chamber housing 310.

The chamber port 315 may be connected or coupled to a vacuum release valve 540. For example, the vacuum release valve 540 may be installed in the chamber port 315.

The chamber unit 300 may include a chamber filter 320. The chamber filter 320 may have a filtering function. For example, at least a portion of the powder applied to the chamber filter 320 may be blocked by the chamber filter 320, and thus movement of the powder may be suppressed.

The chamber filter 320 may be located in the chamber housing 310. For example, the chamber filter 320 may be installed, coupled, or connected to the chamber housing 310.

The chamber filter 320 may partition the chamber housing 310 and the chamber port 315. For example, the hollow portion formed in the chamber housing 310 and the hollow portion formed in the chamber port 315 by the chamber filter 320 may be partitioned or separated by the chamber filter 320. For example, gas (or air) incident on an external face of the chamber filter 320 may pass through the chamber filter 320 and flow into the chamber port 315.

The powder feeding device 10 may include a vacuum pump 740. The vacuum pump 740 may be connected to the chamber unit 300 through a pump pipe 450.

For example, the vacuum pump 740 may maintain the internal pressure (or atmospheric pressure) of the chamber housing 310 and the chamber port 315 to be lower than an external pressure (or atmospheric pressure) of the chamber unit 300.

The powder feeding device 10 may include a valve assembly 500. The valve assembly 500 may include the coupling valve 560. The coupling valve 560 may connect the hopper body 210 to the chamber housing 310. For example, the coupling valve 560 may be connected, coupled, or installed to at least one of the hopper body 210 and the chamber housing 310.

The coupling valve 560 may connect or disconnect the accommodation space formed in the hopper body 210 with the hollow portion formed in the chamber housing 310. In other words, the coupling valve 560 may connect or disconnect the accommodation space formed in the hopper body 210 with the hollow portion formed in the chamber housing 310.

For example, in a state in which the coupling valve 560 is open, the hopper body 210 and the chamber housing 310 may communicate with each other. In a state in which the coupling valve 560 is open, at least a portion of the powder located in the chamber housing 310 may fall and move to the inside of the hopper body 210.

For example, in a state in which the coupling valve 560 is closed, the hollow portion formed in the hopper body 210 and the hollow portion formed in the chamber housing 310 may be separated from each other. In a state in which the coupling valve 560 is closed, an internal pressure (or atmospheric pressure) of the hopper body 210 may be maintained differently from an internal pressure (or atmospheric pressure) of the chamber housing 310.

The valve assembly 500 may include the vacuum release valve 540. The vacuum release valve 540 may be connected, coupled, or installed to the chamber port 315. The vacuum release valve 540 may, for example, open or/and close the hollow portion formed in the chamber port 315.

In a state in which the vacuum release valve 540 is open, the internal pressure (or atmospheric pressure) of the chamber port 315 and the internal pressure (or atmospheric pressure) of the chamber housing 310 may be substantially the same as the external pressure (or atmospheric pressure) of the chamber unit 300.

In a state in which the vacuum release valve 540 is closed, the internal pressure (or atmospheric pressure) of the chamber port 315 and the internal pressure (or atmospheric pressure) of the chamber housing 310 may be maintained lower than the external pressure (or atmospheric pressure) of the chamber unit 300.

The pipe assembly 400 may include the pump pipe 450. The pump pipe 450 may form a shape of a pipe or a tube. The pump pipe 450 may connect the vacuum pump 740 and the chamber unit 300.

For example, the pump pipe 450 may extend from the vacuum pump 740 and lead to the chamber unit 300. For example, the pump pipe 450 may extend from an end of the pump pipe 450 and lead to another end of the pump pipe 450.

For example, the end of the pump pipe 450 may be connected to the vacuum pump 740. The pump pipe 450 may communicate with the chamber port 315. For example, the other end of the pump pipe 450 may be connected to the chamber port 315. For example, the other end of the pump pipe 450 may be located between the chamber housing 310 and the vacuum release valve 540.

The valve assembly 500 may include a vacuum line valve 550. The vacuum line valve 550 may be located, connected, or coupled to the pump pipe 450.

For example, the vacuum line valve 550 may be installed in the pump pipe 450. For example, the vacuum line valve 1'550 may be located on the pump pipe 450 and between the end of the pump pipe 450 and the other end of the pump pipe 450.

When the vacuum pump 740 operates in a state in which the vacuum line valve 550 is open, at least a portion of the gas (or air) located in the chamber housing 310 may reach the vacuum pump 740 via the chamber port 315 and the pump pipe 450.

In a state in which the vacuum line valve 550 is closed, the hollow portion formed in the chamber unit 300 may be separated from the vacuum pump 740 without communicating with the vacuum pump 740. Therefore, even if the vacuum pump 740 operates in a state in which the vacuum line valve 550 is closed, the vacuum line valve 550 can prevent the gas (or air) located in the chamber housing 310 from reaching the vacuum pump 740.

The pipe assembly 400 may include the hopper pipe 420. The hopper pipe 420 may form a shape of a pipe or a tube. The hopper pipe 420 may be connected or coupled to the hopper 200.

For example, an end of the hopper pipe 420 may be connected to the hopper inlet 230. For example, the end of the hopper pipe 420 may be connected to the hopper pipe inlet 231.

The pipe assembly 400 may include a chamber pipe 430. The chamber pipe 430 may form a shape of a pipe or a tube. The chamber pipe 430 may be connected or coupled to a chamber unit 300.

For example, an end of the chamber pipe 430 may be connected to the chamber housing 310. For example, the end of the chamber pipe 430 may be connected to a lower end of the chamber housing 310. For example, the end of the chamber pipe 430 may be located below the chamber port 315.

The pipe assembly 400 may include a branch pipe 440. The branch pipe 440 may connect the container pipe 410, the hopper pipe 420, and the chamber pipe 430 to each other.

For example, the branch pipe 440 may connect the container pipe 410, the hopper pipe 420, and the chamber pipe 430 to each other through the valve assembly 500.

For example, the branch pipe 440 may include a container branch portion 441. The container branch portion 441 may form a shape of a pipe or a tube.

For example, the valve assembly 500 may include the container valve 510. For example, the container valve 510 may connect the container branch portion 441 and the container pipe 410.

For example, in a state in which the container valve 510 is opened, the container branch portion 441 and the container pipe 410 may communicate with each other. For example, in a state in which the container valve 510 is closed, an internal space of the container branch portion 441 may be separated from an internal space of the container pipe 410.

For example, the branch pipe 440 may include a hopper branch portion 442. The hopper branch portion 442 may form a shape of a pipe or a tube.

For example, the valve assembly 500 may include a hopper valve 520. For example, the hopper valve 520 may connect the hopper branch portion 442 and the hopper pipe 420.

For example, in a state in which the hopper valve 520 is opened, the hopper branch portion 442 and the hopper pipe 420 may communicate with each other. For example, in a state in which the hopper valve 520 is closed, an internal space of the hopper branch portion 442 may be separated from an internal space of the hopper pipe 420.

For example, the branch pipe 440 may include a chamber branch portion 443. The chamber branch portion 443 may form a shape of a pipe or a tube.

For example, the valve assembly 500 may include a chamber valve 530. For example, the chamber valve 530 may connect the chamber branch portion 443 and the chamber pipe 430.

For example, in a state in which the chamber valve 530 is opened, the chamber branch portion 443 and the chamber pipe 430 may communicate with each other. For example, in a state in which the chamber valve 530 is closed, an internal space of the chamber branch portion 443 may be separated from an internal space of the chamber pipe 430.

The container branch portion 441, the hopper branch portion 442, and the chamber branch portion 443 may be connected to each other. For example, an end of the container branch portion 441, an end of the hopper branch portion 442, and an end of the chamber branch portion 443 may be connected and communicate with each other at a point.

For example, another end of the container branch portion 441 may be connected to the container valve 510. For example, another end of the hopper branch portion 442 may be connected to the hopper valve 520. For example, another end of the chamber branch portion 443 may be connected to the chamber valve 530.

The powder feeding device 10 may include an outer filter 610. The outer filter 610 may be connected to at least one of the chamber port 315 and the vacuum release valve 540. For example, the outer filter 610 may be connected or coupled to the chamber port 315.

In a state in which the vacuum release valve 540 is closed, the internal pressure (or atmospheric pressure) of the chamber housing 310 may be lower than the external pressure (or atmospheric pressure) of the chamber unit 300.

In this state, when the vacuum release valve 540 is opened, gas (or air) located outside the chamber unit 300 may flow into the inside of the chamber unit 300. The outer filter 610 may prevent foreign substances (e.g., dust, etc.) mixed in the gas (or air) located outside the chamber unit 300 from being introduced into the inside of the chamber unit 300.

The powder feeding device 10 may include a vacuum filter unit 620. The vacuum filter unit 620 may include a vacuum filter housing 621. The vacuum filter housing 621 may be located or installed in the pump pipe 450. For example, the vacuum filter housing 621 may be located on the pump pipe 450 and between the vacuum line valve 550 and the vacuum pump 740.

The vacuum filter unit 620 may include a vacuum filter 622. The vacuum filter 622 may be located in the vacuum filter housing 621. The vacuum filter 622 may prevent foreign substances (e.g., dust, powder, etc.) located inside the pump pipe 450 from being introduced into the vacuum pump 740.

For example, gas (or air) located in the chamber unit 300 may flow into the pump pipe 450 and may be incident on a face of the vacuum filter 622. At least a portion of the gas (or air) incident on the face of the vacuum filter 622 may pass through the vacuum filter 622 and flow toward the vacuum pump 740.

In this process, the vacuum filter 622 can prevent at least a portion of the foreign substances mixed in the gas (or air) located in the chamber unit 300 from being introduced into the vacuum pump 740.

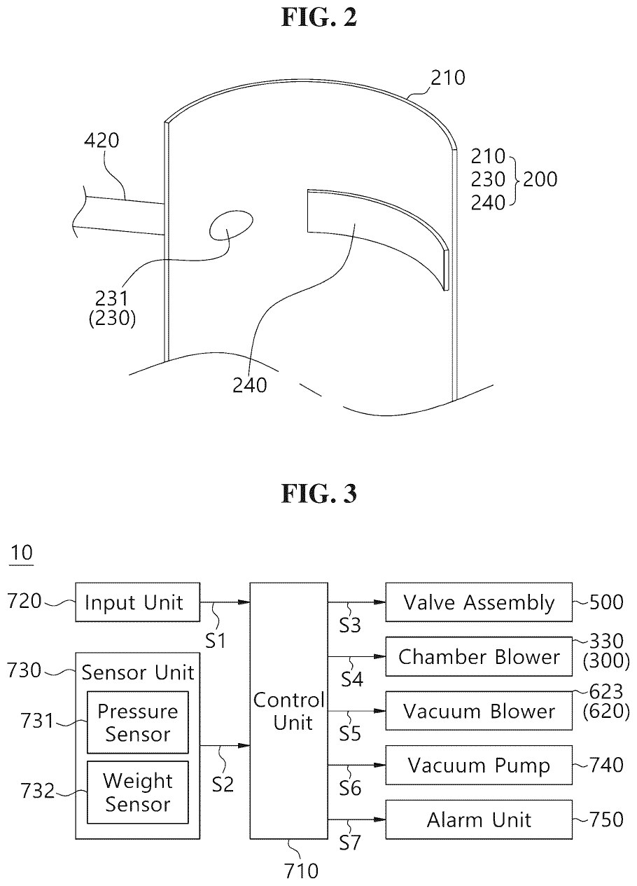

FIG. 2 illustrates a cut-away view of a part of a hopper illustrated in FIG. 1.

Referring to FIG. 2, the hopper 200 may include a wear prevention plate 240. The wear-resistant plate 240 may be located inside the hopper body 210. For example, the wear prevention plate 240 may be installed inside the hopper body 210.

The hopper pipe 420 may be connected to the hopper pipe inlet 231. For example, at least a portion of the powder located in the hopper pipe 420 may pass through the hopper pipe inlet 231 and flow into the inside of the hopper body 210.

The wear prevention plate 240 may face the hopper pipe inlet 231. For example, at least a portion of the powder that passes through the hopper pipe inlet 231 and flows into the inside of the hopper body 210 may be incident on the wear prevention plate 240. Accordingly, the wear prevention plate 240 can prevent an impact applied to the hopper body 210 by the powder incident on the hopper body 210.

FIG. 3 is a block diagram of a powder feeding device according to an embodiment of the disclosure.

Referring to FIGS. 1 to 3, the powder feeding device 10 may include a control unit 710. The control unit 710 may process signals. For example, the control unit 710 may perform calculations.

For example, the control unit 710 may be implemented through at least one of a processor, a computer, a server, an electric circuit, or a circuit board.

The powder feeding device 10 may include an input unit 720. The input unit 720 may obtain an input from a user, etc. The input unit 720 may generate a first signal S1 and transmit the first signal S1 to the control unit 710.

The first signal S1 may include information on the input. For example, the first signal S1 may include command information about an operation of at least one of the valve assembly 500, a chamber blower 330, a vacuum blower 623, or the vacuum pump 740.

The powder feeding device 10 may include a sensor unit 730. The sensor unit 730 may include a pressure sensor 731. A plurality of pressure sensors 731 may be provided.

For example, the pressure sensor 731 may be coupled to the chamber unit 300. For example, the pressure sensor 731 may measure the internal pressure (or atmospheric pressure) of the chamber unit 300. For example, the pressure sensor 731 may measure an internal atmospheric pressure of the chamber housing 310 or/and an internal atmospheric pressure of the chamber port 315. A second signal S2 may include information on the internal atmospheric pressure of the chamber housing 310 or the internal atmospheric pressure of the chamber port 315.

When a relatively large amount of foreign substances are attached to the chamber filter 320, the internal pressure (or atmospheric pressure) of the chamber unit 300 may be relatively high. When the internal pressure (or atmospheric pressure) of the chamber unit 300 is relatively high, the control unit 710 may determine that the relatively large amount of foreign substances are attached to the chamber filter 320.

If it is determined that the relatively large amount of foreign substances are attached to the chamber filter 320, the control unit 710 may generate at least one of a fourth signal S4 and a seventh signal S7.

The fourth signal S4 may include information on an operation command of the chamber blower 330 and may be transmitted to the chamber blower 330. The seventh signal S7 may include alarm information on an abnormality of the chamber filter 320 and may be transmitted to an alarm unit 750.

For example, the pressure sensor 731 may be coupled to the vacuum filter housing 621. For example, the pressure sensor 731 may measure an internal pressure of the vacuum filter housing 621.

For example, the pressure sensor 731 may measure a pressure difference between two different points. For example, the pressure sensor 731 may measure a difference between a pressure at a point facing a face of the vacuum filter 622 and a pressure at a point facing another face of the vacuum filter 622.

The “pressure difference” refer to a difference between a pressure at a point facing a face of the vacuum filter 622 and a pressure at a point facing another face of the vacuum filter 622.

The second signal S2 may include information on the difference between the pressure at the point facing the face of the vacuum filter 622 and the pressure at the point facing the other face of the vacuum filter 622. That is, the second signal S2 may include information on the pressure difference.

If the difference between the pressure at the point facing the face of the vacuum filter 622 and the pressure at the point facing the other face of the vacuum filter 622 is relatively large, the control unit 710 may determine that a relatively large amount of foreign substances are attached to the vacuum filter 622.

If it is determined that the relatively large amount of foreign substances are attached to the vacuum filter 622, the control unit 710 may generate at least one of a fifth signal S5 and the seventh signal S7.

The fifth signal S5 may include information on an operation command of the vacuum blower 623 and may be transmitted to the vacuum blower 623. The seventh signal S7 may include alarm information on an abnormality of the vacuum filter unit 620 and may be transmitted to the alarm unit 750.

The sensor unit 730 may include a weight sensor 732. The weight sensor 732 may be coupled to the hopper 200. For example, the weight sensor 732 may be coupled or connected to the hopper body 210. For example, the weight sensor 732 may include a load cell.

For example, the weight sensor 732 may measure a weight of the hopper body 210. The weight of the hopper body 210 may vary depending on an amount of powder accommodated in the hopper body 210. Therefore, the weight sensor 732 may measure the weight of the powder accommodated in the hopper body 210.

For example, the weight sensor 732 may measure the weights of the hopper body 210 and the chamber unit 300. The weight of the hopper body 210 may vary depending on the amount of powder accommodated in the hopper body 210. The weight of the chamber unit 300 may vary depending on an amount of powder accommodated in the chamber housing 310. Therefore, the weight sensor 732 may measure the weight of the powder accommodated in the hopper body 210 and the chamber housing 310.

The sensor unit 730 may generate the second signal S2 and transmit the second signal S2 to the control unit 710. The second signal S2 may include at least one of information on the internal atmospheric pressure of the chamber unit 300 and information on the weight of the powder accommodated in the hopper body 210.

The control unit 710 may generate output signals S3, S4, S5, S6, and S7 based on input signals S1 and S2. For example, the input signals S1 and S2 may include at least one of the first signal S1 and the second signal S2. For example, the output signals S3, S4, S5, S6, and S7 may include at least one of the third signal S3, the fourth signal S4, the fifth signal S5, the sixth signal S6, or the seventh signal S7.

The valve assembly 500 may receive the third signal S3. The third signal S3 may include information on an operation command of the valve assembly 500. The valve assembly 500 may operate in response to the third signal S3.

The chamber unit 300 may include the chamber blower 330. The chamber blower 330 may be connected or coupled to at least one of the chamber housing 310 and the chamber port 315. For example, the chamber blower 330 may be connected or coupled to the chamber housing 310. The chamber blower 330 may receive the fourth signal S4 and operate in response to the fourth signal S4.

The chamber blower 330 may provide gas (or air) to the chamber filter 320. For example, the chamber blower 330 may spray gas (or air) into the chamber filter 320. Hence, at least a portion of the foreign substances attached to the chamber filter 320 can be separated from the chamber filter 320.

The vacuum filter unit 620 may include the vacuum blower 623. The vacuum blower 623 may be connected or coupled to the vacuum filter housing 621. The vacuum blower 623 may receive the fifth signal S5 and operate in response to the fifth signal S5.

The vacuum blower 623 may provide gas (or air) to the vacuum filter 622. For example, the vacuum blower 623 may spray gas (or air) into the vacuum filter 622. Hence, at least a portion of the foreign substances attached to the vacuum filter 622 can be separated from the vacuum filter 622.

The vacuum pump 740 may operate in response to the sixth signal S6. The vacuum pump 740 may suck gas (or air) located in the pump pipe 450. Hence, the vacuum pump 740 may maintain an internal atmospheric pressure of the pump pipe 450 to be lower than an external atmospheric pressure of the vacuum pump 740.

The powder feeding device 10 may include the alarm unit 750. The alarm unit 750 may receive the seventh signal S7 and operate in response to the seventh signal S7.

The alarm unit 750 may include a display. The alarm unit 750 may provide information on a state of the filters 320 and 622 to an operator.

For example, the alarm unit 750 may display an alarm about the abnormality of the filters 320 and 622. For example, the alarm unit 750 may include a speaker. For example, the alarm unit 750 may express the alarm about the abnormality of the filters 320 and 622 as an auditory signal.

The operation of the powder feeding device 10 is described. The powder stored in the container 100 may be transferred to the inside of the hopper body 210. For example, at least a portion of the powder stored in the container 100 may be transferred to the inside of the hopper body 210 due to a difference in the atmospheric pressure (or pressure).

For example, a method of transferring the powder stored in the container 100 to the inside of the hopper body 210 may be divided into two transfer modes. For example, a first transfer mode may indicate a transfer method in which a relatively large amount of powder is transferred from the container 100 to the hopper 200. For example, a second transfer mode may indicate a transfer method in which a relatively small amount of powder is transferred from the container 100 to the hopper 200.

For example, in the first transfer mode, at least a portion of the powder stored in the container 100 may sequentially pass through the container pipe 410 and the hopper pipe 420 and may be transferred to the inside of the hopper body 210.

For example, in the second transfer mode, at least a portion of the powder stored in the container 100 may sequentially pass through the container pipe 410, the chamber pipe 430, and the chamber unit 300 and may be transferred to the inside of the hopper body 210.

The process of transferring the powder stored in the container 100 to the inside of the hopper body 210 may be divided in time series. For example, 80% to 90% of the powder to be transferred to the inside of the hopper body 210 may be transferred from the container 100 to the hopper 200 in the first transfer mode, and then the remaining powder may be transferred from the container 100 to the hopper 200 in the second transfer mode.

The operation of the valve assembly 500 may vary depending on the transfer mode.

For example, in the first transfer mode, the container valve 510, the hopper valve 520, the vacuum line valve 550, and the coupling valve 560 may be maintained in an open state. For example, in the first transfer mode, the chamber valve 530 and the vacuum release valve 540 may be maintained in a closed state.

In the first transfer mode, the vacuum pump 740 may operate. When the vacuum pump 740 operates, the internal atmospheric pressure (or pressure) of the pump pipe 450 may be lower than the external atmospheric pressure.

When the internal atmospheric pressure (or pressure) of the pump pipe 450 is lower than the external atmospheric pressure, the internal atmospheric pressure of the chamber port 315 and the chamber housing 310 may be lower than the external atmospheric pressure.

When the internal atmospheric pressure of the chamber port 315 and the chamber housing 310 is lower than the external atmospheric pressure, the internal pressure of the hopper body 210 may be lower than the external atmospheric pressure. For example, the internal pressure of the hopper body 210 may be lower than the internal atmospheric pressure of the container body 110.

When the internal pressure of the hopper body 210 is lower than the internal atmospheric pressure of the container body 110, at least a portion of the powder accommodated in the hopper body 210 may sequentially pass through the container pipe 410 and the hopper pipe 420 and flow into the inside of the hopper body 210.

As the powder flows into the hopper body 210 in the first transfer mode, the amount of powder measured by the weight sensor 732 may vary. If the amount of powder measured by the weight sensor 732 is less than a first reference powder amount, the first transfer mode may be maintained. If the amount of powder measured by the weight sensor 732 is greater than or equal to the first reference powder amount, the first transfer mode may be terminated and the second transfer mode may be started.

In the second transfer mode, the container valve 510, the chamber valve 530, and the vacuum line valve 550 may be maintained in an open state. In the second transfer mode, the hopper valve 520, the vacuum release valve 540, and the coupling valve 560 may be maintained in a closed state.

In the second transfer mode, at least a portion of the powder contained in the container 100 may sequentially pass through the container pipe 410 and the hopper pipe 430 due to a difference in the atmospheric pressure and be introduced into the inside of the chamber housing 310. When the coupling valve 560 is opened, at least a portion of the powder located in the chamber housing 310 may pass through the coupling valve 560 and be introduced into the inside of the hopper body 210.

As the powder is introduced into the hopper body 210 in the second transfer mode, the amount of powder measured by the weight sensor 732 may vary. If the amount of powder measured by the weight sensor 732 is less than a second reference powder amount, the second transfer mode may be maintained. If the amount of powder measured by the weight sensor 732 is greater than or equal to the second reference powder amount, the second transfer mode may be terminated.

The second reference powder amount may be greater than the first reference powder amount. For example, the first reference powder amount may be 80% to 90% of the second reference powder amount.

For example, powder as much as the first reference powder amount may be transferred in the first transfer mode, and powder by subtracting the first reference powder amount from the second reference powder amount may be transferred in the second transfer mode.

In the second transfer mode, at least one of the container valve 510 and the chamber valve 530 may be opened or closed in order to precisely measure the transferred powder. For example, in the second transfer mode, at least one of the container valve 510 and the chamber valve 530 may be opened or closed one or more times.

As a result, powder as much as the second reference powder amount can be transferred more accurately and quickly from the inside of the container 100 to the inside of the hopper body 210.

In the process of transferring the powder stored in the container 100 to the inside of the hopper body 210, the internal atmospheric pressure of the hopper body 210 may be maintained lower than the internal atmospheric pressure of the container 100.

In order for the internal atmospheric pressure of the hopper body 210 to be maintained lower than the internal atmospheric pressure of the container 100, the gas (or air) located inside the hopper body 210 may pass through the filters 320 and 622. The filter (320, 622) may include or indicate at least one of the chamber filter 320 and the vacuum filter 622.

In the process of the gas (or air) passing through the filters 320 and 622, foreign substances (e.g., dust or powder, etc.) mixed in the gas (or air) may be attached to the filters 320 and 622.

The foreign substances (e.g., dust or powder, etc.) attached to the filters 320 and 622 can prevent the internal atmospheric pressure of the hopper body 210 from forming a negative pressure.

The negative pressure may refer to a pressure when a value by subtracting the internal atmospheric pressure of the container body 110 from the internal atmospheric pressure of the hopper body 210 is a negative value.

That is, the foreign substances (e.g., dust or powder, etc.) attached to the filters 320 and 622 can prevent the powder from being transferred from the container 100 to the inside of the hopper body 210. A reference chamber internal pressure may be, for example, less than 1 atmosphere (atm). For example, the reference chamber internal pressure may be 0.5 atm.

For example, if the internal atmospheric pressure of the chamber housing 310 is greater than or equal to the reference chamber internal pressure, the foreign substances (e.g., dust or powder, etc.) attached to the filters 320 and 622 need to be separated from the filters 320 and 622. The chamber unit 300 may be referred to as a “chamber.”

A process of separating the foreign substances attached to the chamber filter 320 from the chamber filter 320 may be described. The process of separating the foreign substances attached to the chamber filter 320 from the chamber filter 320 may vary depending on the transfer mode.

For example, a process of separating the foreign substances attached to the chamber filter 320 from the chamber filter 320 in the first transfer mode may be referred to as a “first blowing mode.”

In the first blowing mode, the vacuum line valve 550 and the coupling valve 560 may be closed, and the vacuum release valve 540 may be opened. In the first blowing mode, after the chamber blower 330 operates, the vacuum line valve 550 and the coupling valve 560 may be opened and the vacuum release valve 540 may be closed.

For example, a process of separating the foreign substances attached to the chamber filter 320 from the chamber filter 320 in the second transfer mode may be referred to as a “second blowing mode.”

In the second blowing mode, the chamber valve 530 and the vacuum line valve 550 may be closed, and the vacuum release valve 540 may be opened. In the second blowing mode, after the chamber blower 330 operates, the chamber valve 530 and the vacuum line valve 550 may be opened, and the vacuum release valve 540 may be closed.

In the first blowing mode and the second blowing mode, the chamber blower 330 may spray gas (or air) toward the chamber filter 320. When the chamber blower 330 sprays gas (or air) toward the chamber filter 320, the foreign substances attached to the chamber filter 320 may be separated from the chamber filter 320.

In a state in which the coupling valve 560, the chamber valve 530, and the vacuum line valve 550 are closed, the internal atmospheric pressure of the chamber housing 310 may be lower than an external atmospheric pressure of the chamber housing 310.

When the vacuum release valve 540 is opened in a state in which the internal atmospheric pressure of the chamber housing 310 is lower than the external atmospheric pressure of the chamber housing 310, external air (or gas) may pass through the vacuum release valve 540 and be applied to the chamber filter 320.

When the external air (or gas) is applied to the chamber filter 320, the foreign substances attached to the chamber filter 320 may be separated from the chamber filter 320. That is, when the internal atmospheric pressure of the chamber housing 310 is lower than the external atmospheric pressure of the chamber housing 310, the vacuum release valve 540 may perform the function of the chamber blower 330.

A plurality of chamber units 300 may be provided. For example, the powder feeding device 10 may include the plurality of chamber units 300. The number of chamber pipes 430, the number of coupling valves 560, the number of chamber valves 530, the number of vacuum release valves 540, the number of vacuum line valves 550, and the number of pump pipes 450 may depend on the number of chamber units 300.

The number of chamber units 300 operating among the plurality of chamber units 300 may vary depending on the amount of powder to be transferred from the container 100.

For example, if the amount of powder to be transferred from the container 100 is relatively large, the number of chamber units 300 operating among the plurality of chamber units 300 may relatively large.

For example, when the amount of powder to be transferred from the container 100 is relatively small, the number of chamber units 300 operating among the plurality of chamber units 300 may relatively small.

The number of chamber units 300 operating among the plurality of chamber units 300 may vary depending on an amount of powder that has been transferred among the powder to be transferred from the container 100.

For example, the number of chamber units 300 operating among the plurality of chamber units 300 may vary over time. For example, in the powder transfer process, the number of chamber units 300 operating in the early and middle stages of the powder transfer process may be relatively large, and the number of chamber units 300 operating in the latter stage of the powder transfer process may be relatively small. As a result, the powder can be precisely measured and transferred.

The atmospheric pressure inside the chamber housing 310 of each of the plurality of chamber units 300 may be measured.

If the internal atmospheric pressure of some of the respective chamber housings 310 of the plurality of chamber units 300 is greater than or equal to the reference chamber internal pressure, the control unit 710 may spray gas (or air) into the chamber filter 320 of the chamber unit 300 forming a low internal atmospheric pressure.

If the internal atmospheric pressure of all the respective chamber housings 310 of the plurality of chamber units 300 is greater than or equal to the reference chamber internal pressure, the control unit 710 may blow the chamber filters 320 of all the plurality of chamber units 300. In this case, the control unit 710 may operate the vacuum blower 623 to spray gas (or air) into the vacuum filter 622.

The container pipe 410 and the container branch portion 441 may be formed integrally. For example, a “container pipe unit” may include the container pipe 410 and the container branch portion 441.

For example, an end of the container pipe unit (410, 441) may be connected to the container 100, and another end of the container pipe unit (410, 441) may be connected to the hopper branch portion 442 and the chamber branch portion 443. The container valve 510 may be installed or coupled to the container pipe unit (410, 441). The container valve 510 may open or close the container pipe unit (410, 441).

The hopper pipe 420 and the hopper branch portion 442 may be formed integrally. For example, a “hopper pipe unit” may include the hopper pipe 420 and the hopper branch portion 442.

For example, an end of the hopper pipe unit (420, 442) may be connected to the hopper body 210, and another end of the hopper pipe unit (420, 442) may be connected to the container branch portion 441 and the chamber branch portion 443. The hopper valve 520 may be installed or coupled to the hopper pipe unit (420, 442). The hopper valve 520 may open or close the hopper pipe unit (420, 442).

The chamber pipe 430 and the chamber branch portion 443 may be formed integrally. For example, a “chamber pipe unit” may include the chamber pipe 430 and the chamber branch portion 443.

For example, an end of the chamber pipe unit (430, 443) may be connected to the chamber housing 310, and another end of the chamber pipe unit (430, 443) may be connected to the container branch portion 441 and the hopper branch portion 442. The chamber valve 530 may be installed or coupled to the chamber pipe unit (430, 443). The chamber valve 530 may open or close the chamber pipe unit (430, 443).

The container pipe unit (410, 441) may be branched from the other end of the container pipe unit (410, 441) and may lead to the hopper pipe unit (420, 442) and the chamber pipe unit (430, 443).

For example, the powder contained in the container 100 may pass through the container pipe unit (410, 441) and flow into the hopper pipe unit (420, 442) or/and the chamber pipe unit (430, 443).

For example, in a state in which the container valve 510 and the hopper valve 520 are opened and the chamber valve 530 is closed, the powder contained in the container 100 may pass through the container pipe unit (410, 441) and flow into the hopper pipe unit (420, 442).

For example, in a state in which the container valve 510 and the chamber valve 530 are opened and the hopper valve 520 is closed, the powder accommodated in the container 100 may pass through the container pipe unit (410, 441) and flow into the chamber pipe unit (430, 443).

The filter (320, 622) may include or indicate at least one of the chamber filter 320 and the vacuum filter 622. The blower (330, 623) may include or indicate at least one of the chamber blower 330 and the vacuum blower 623.

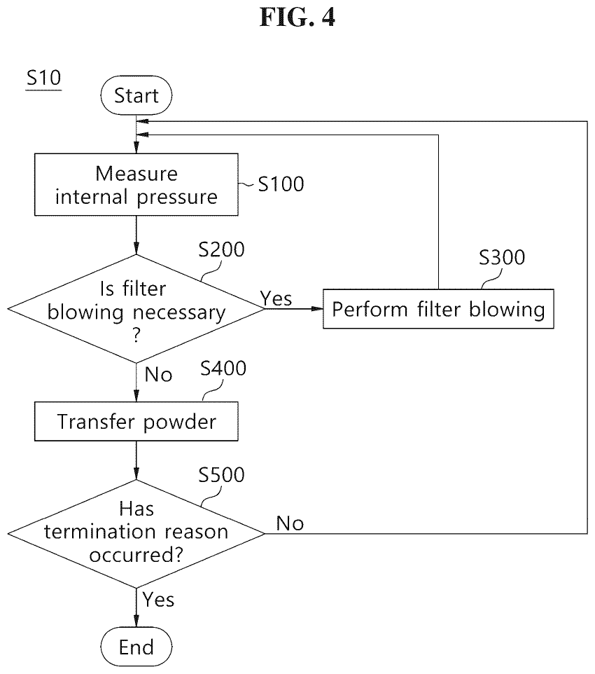

FIG. 4 is a flow chart illustrating a powder transfer method according to an embodiment of the disclosure.

Referring to FIGS. 1 to 4, a powder transfer method S10 may include a step S100 of measuring an internal pressure. The internal pressure may include or indicate at least one of an internal pressure of the chamber housing 310 and a pressure difference of the vacuum filter housing 621.

In the step S100, the pressure sensor 731 may measure the internal pressure of the chamber housing 310. In the step S100, the sensor unit 730 may generate the second signal S2 including information on the internal pressure of the chamber housing 310 and transmit the second signal S2 to the control unit 710.

In the step S100, the pressure sensor 731 may measure the pressure difference of the vacuum filter housing 621. In the step S100, the sensor unit 730 may generate the second signal S2 including information on the pressure difference of the vacuum filter housing 621 and transmit the second signal S2 to the control unit 710.

In the step S100, the sensor unit 730 may transmit the second signal S2 including at least one of the information on the internal pressure of the chamber housing 310 and the information on the pressure difference of the vacuum filter housing 621 to the control unit 710.

The powder transfer method S10 may include a step S200 of determining whether filter blowing is necessary. In the step S200, the control unit 710 may determine whether gas (or air) needs to be sprayed into the filters 320 and 622.

For example, in the step S200, the control unit 710 may compare a chamber internal pressure with a reference chamber internal pressure. The chamber internal pressure may refer to an internal pressure of the chamber housing 310.

In the step S200, the control unit 710 may determine whether the chamber internal pressure extracted from the second signal S2 is greater than or equal to the reference chamber internal pressure. If the chamber internal pressure is greater than or equal to the reference chamber internal pressure, the control unit 710 may determine that gas needs to be sprayed into the chamber filter 320.

For example, in the step S200, the control unit 710 may compare the pressure difference of the vacuum filter housing 621 with a reference pressure difference.

For example, in the step S200, the control unit 710 may determine that the vacuum filter 622 needs to be replaced if the pressure difference extracted from the second signal S2 is greater than or equal to the reference pressure difference.

For example, if the pressure difference extracted from the second signal S2 is greater than or equal to the reference pressure difference, the control unit 710 may transmit the seventh signal S7 to the alarm unit 750. The alarm unit 750 may generate an alarm about an abnormality of the vacuum filter 622 in response to the seventh signal S7. An operator or the like may recognize a state of the vacuum filter 622 through the alarm generated by the alarm unit 750. The operator may replace the vacuum filter 622.

For another example, in the step S200, if the pressure difference extracted from the second signal S2 is greater than or equal to the reference pressure difference, the control unit 710 may determine that gas needs to be sprayed into the vacuum filter 622.

The powder transfer method S10 may include a filter blowing step S300. If the chamber internal pressure is determined to be greater than or equal to the reference chamber internal pressure or the pressure difference is determined to be greater than or equal to the reference pressure difference, the control unit 710 may perform the step S300.

In the step S300, the control unit 710 may operate the chamber blower 330. For example, if the chamber internal pressure is determined to be greater than or equal to the reference chamber internal pressure, the chamber blower 330 may operate in response to the fourth signal S4.

In the step S300, the control unit 710 may operate the vacuum blower 623. For example, if the pressure difference is determined to be greater than or equal to the reference pressure difference, the vacuum blower 623 may operate in response to the fifth signal S5.

For example, if the internal pressure of all the respective chamber housings 310 of the plurality of chamber units 300 is greater than or equal to the reference chamber internal pressure, the control unit 710 may operate the vacuum blower 623.

In the step S300, an operation time and an operation output of at least one of the chamber blower 330 and the vacuum blower 623 may be preset. For another example, in the step S300, the operation time and the operation output of at least one of the chamber blower 330 and the vacuum blower 623 may vary depending on the chamber internal pressure. For example, in the step S300, the operation time and the operation output of the vacuum blower 623 may vary depending on the pressure difference.

For example, the operation time and the operation output of at least one of the chamber blower 330 and the vacuum blower 623 may have a positive correlation with a value by subtracting the reference chamber internal pressure from the chamber internal pressure.

For example, the operation time and the operation output of the vacuum blower 623 may have a positive correlation with a value by subtracting the reference pressure difference from the pressure difference.

The powder transfer method S10 may include a powder transfer step S400. If it is determined that there is no need to spray gas (or air) into the filters 320 and 622, the control unit 710 may perform the step S400.

In the step S400, the control unit 710 may operate the valve assembly 500 and the vacuum pump 740. In the step S400, at least a portion of the powder stored in the container 100 may be transferred to at least one of the hopper body 210 and the chamber housing 310.

The powder transfer method S10 may include a step S500 of determining whether a termination reason has occurred. For example, if an amount of the transferred powder is greater than or equal to the second reference powder amount, it may be determined that the termination reason has occurred.

The powder transfer step S400 may be performed in parallel with the internal pressure measurement step S100. For example, if it is determined that gas (or air) needs to be sprayed into the filters 320 and 622 while the powder transfer step S400 is being performed, the powder transfer step S400 may be stopped and the filter blowing step S300 may be performed.

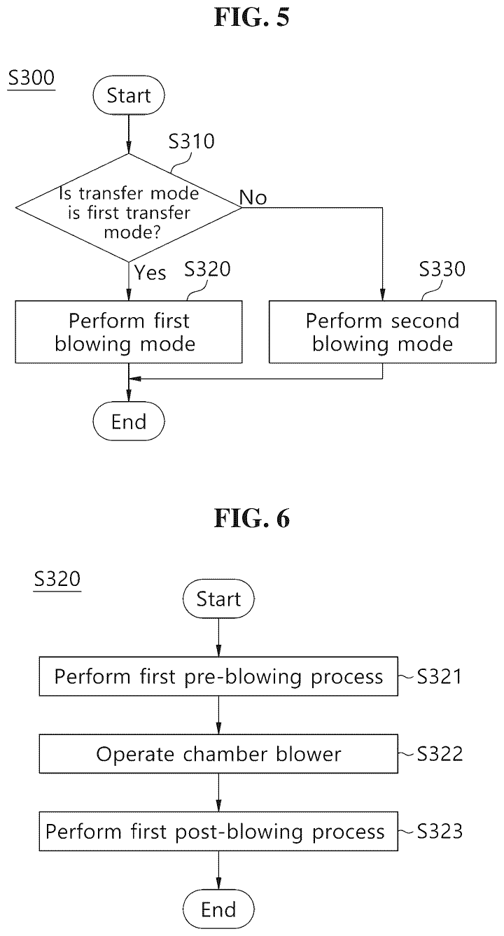

FIG. 5 is a flowchart illustrating a filter blowing step.

Referring to FIGS. 1 to 5, the filter blowing step S300 may include a step S310 of determining a transfer mode. In the step S310, the control unit 710 may determine whether the transfer mode is the first transfer mode. For example, the control unit 710 may determine the amount of powder transferred to the hopper body 210 and the chamber housing 310 based on the second signal S2.

For example, if the amount of powder transferred to the hopper body 210 and the chamber housing 310 is less than the first reference powder amount, the control unit 710 may determine that the transfer mode is the first transfer mode.

For example, if the amount of powder transferred to the hopper body 210 and the chamber housing 310 is greater than or equal to the first reference powder amount and less than the second reference powder amount, the control unit 710 may determine that the transfer mode is the second transfer mode.

For example, the transfer mode may be included in the first signal S1. In this case, regardless of the second signal S2, the transfer mode may be determined based on the first signal S1.

The filter blowing step S300 may include a step S320 of performing a first blowing mode. If the transfer mode is determined to be the first transfer mode, the control unit 710 may perform the step S320.

The filter blowing step S300 may include a step S330 of performing a second blowing mode. If it is determined that the transfer mode is not the first transfer mode, the control unit 710 may perform the step S330. That is, if it is determined that the transfer mode is the second transfer mode, the control unit 710 may perform the step S330.

FIG. 6 is a flowchart illustrating a step of performing a first blowing mode.

Referring to FIGS. 1 to 6, the first blowing mode performing step S320 may include a step S321 of performing a first pre-blowing process. For example, if the chamber internal pressure is greater than or equal to the reference chamber internal pressure, the step S321 may be performed. In the step S321, the chamber unit 300 may communicate with the outside through the vacuum release valve 540.

For example, in the step S321, the control unit 710 may control the vacuum line valve 550, the coupling valve 560, and the vacuum release valve 540. In the step S321, the vacuum line valve 550 and the coupling valve 560 may be closed, and the vacuum release valve 540 may be opened.

The first blowing mode performing step S320 may include a blower operation step S322. In the step S322, the blowers 330 and 623 may spray gas (or air) into the filters 320 and 622.

For example, in the step S322, gas (or air) may be sprayed into the chamber filter 320. For example, in the step S322, the chamber blower 330 may spray gas (or air) into the chamber filter 320.

For example, in the step S322, gas (or air) may be sprayed into the vacuum filter 622. For example, in the step S322, the vacuum blower 623 may spray gas (or air) into the vacuum filter 622.

For another example, in the step S322, the vacuum filter 622 may be replaced with a new vacuum filter 622. The replacement of the vacuum filter 622 may be performed manually or automatically.

The first blowing mode performing step S320 may include a step S323 of performing a first post-blowing process. In the step S323, the control unit 710 may control the vacuum line valve 550, the coupling valve 560, and the vacuum release valve 540. In the step S323, the vacuum line valve 550 and the coupling valve 560 may be opened, and the vacuum release valve 540 may be closed.

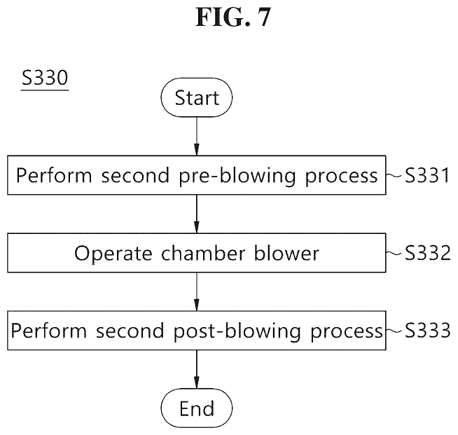

FIG. 7 is a flowchart illustrating a step of performing a second blowing mode.

Referring to FIGS. 1 to 7, the second blowing mode performing step S330 may include step S331 of performing a second pre-blowing process. For example, if the chamber internal pressure is greater than or equal to the reference chamber internal pressure, the step S331 may be performed.

In the step S331, the control unit 710 may control the vacuum line valve 550, the chamber valve 530, and the vacuum release valve 540. In the step S331, the vacuum line valve 550 and the chamber valve 530 may be closed, and the vacuum release valve 540 may be opened.

The second blowing mode performing step S330 may include a blower operation step S332. In the step S332, the blowers 330 and 623 may spray gas (or air) into the filters 320 and 622.

For example, in the step S332, air (or gas) may be sprayed into the chamber filter 320. For example, in the step S332, the chamber blower 330 may spray gas (or air) into the chamber filter 320.

For example, in the step S332, gas (or air) may be sprayed into the vacuum filter 622. For example, in the step S332, the vacuum blower 623 may spray gas (or air) into the vacuum filter 622.

For another example, in the step S332, the vacuum filter 622 may be replaced with a new vacuum filter 622. The replacement of the vacuum filter 622 may be performed manually or automatically.

The second blowing mode performing step S330 may include a step S333 of performing a second post-blowing process. In the step S333, the control unit 710 may control the vacuum line valve 550, the chamber valve 530, and the vacuum release valve 540. In the step S333, the vacuum line valve 550 and the chamber valve 530 may be opened, and the vacuum release valve 540 may be closed.

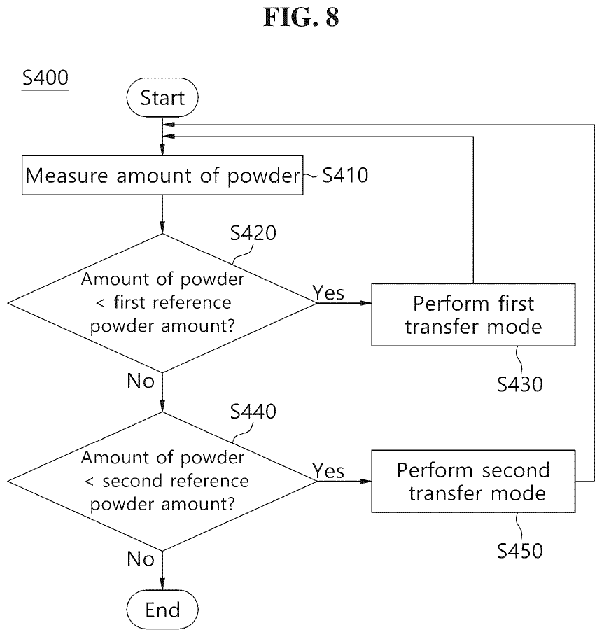

FIG. 8 is a flowchart illustrating the powder transfer step S400.

Referring to FIGS. 1 to 8, the powder transfer step S400 may include a step S410 of measuring a powder amount. In the step S410, the sensor unit 730 may measure an amount of powder located in the hopper body 210 and the chamber unit 300. The second signal S2 may include information on the amount of powder located in the hopper body 210 and the chamber unit 300.

The powder transfer step S400 may include a step S420 of comparing an amount of the transferred powder with the first reference powder amount. In the step S420, the control unit 710 may determine whether the amount of powder located in the hopper body 210 and the chamber unit 300 is less than the first reference powder amount.

The powder transfer step S400 may include a step S430 of performing a first transfer mode. If the amount of powder located in the hopper body 210 and the chamber unit 300 is determined to be less than the first reference powder amount, the step S430 may be performed. The step S430 and the powder amount measurement step S410 may be performed in parallel.

In the step S430, the container valve 510, the hopper valve 520, the coupling valve 560, and the vacuum line valve 550 may maintain an open state. In the step S430, the chamber valve 530 and the vacuum release valve 540 may maintain a closed state. In the step S430, the vacuum pump 740 may operate, and the internal atmospheric pressure of the hopper body 210 may be lower than the internal atmospheric pressure of the container body 110.

In the step S430, at least a portion of the powder accommodated in the container 100 may sequentially pass through the container pipe 410 and the hopper pipe 420 and be transferred to the inside of the hopper body 210.

The powder transfer step S400 may include a step S440 of comparing an amount of the transferred powder with the second reference powder amount. If it is determined that the amount of the powder located in the hopper body 210 and the chamber unit 300 is not less than the first reference powder amount, the step S440 may be performed.

For example, if it is determined that the amount of the powder located in the hopper body 210 and the chamber unit 300 is greater than or equal to the first reference powder amount, the step S440 may be performed.

In the step S440, the control unit 710 may determine whether the amount of the powder located in the hopper body 210 and the chamber unit 300 is less than the second reference powder amount.

The powder transfer step S400 may include a step S450 of performing a second transfer mode. If it is determined that the amount of the powder located in the hopper body 210 and the chamber unit 300 is less than the second reference powder amount, the step S450 may be performed. The step S450 and the powder amount measurement step S410 may be performed in parallel.

In the step S450, the container valve 510, the chamber valve 530, and the vacuum line valve 550 may maintain an open state. In the step S450, the hopper valve 520, the coupling valve 560, and the vacuum release valve 540 may maintain a closed state. In the step S450, the vacuum pump 740 may operate, and the internal atmospheric pressure of the chamber housing 310 may be lower than the internal atmospheric pressure of the container body 110.

For another example, in the step S450, at least one of the container valve 510 and the chamber valve 530 may be opened or closed one or more times.

For example, at least one of the container valve 510 and the chamber valve 530 may be kept open during an “opening period” and then closed. The shorter the opening period, the more precisely the amount of powder to be transferred may be controlled.

For example, if the container valve 510 is kept open during the opening period and then closed, an amount of powder to be transferred and added to the chamber housing 310 may be less than or equal to an amount of powder accommodated in the chamber pipe 430. As a result, the amount of powder transferred to the chamber housing 310 can be controlled.

If the amount of powder transferred to the chamber unit 300 and the hopper body 210 is less than the second reference powder amount, the process in which the container valve 510 is kept open during the opening period and then closed may be repeated.

In the step S450, the internal atmospheric pressure of the chamber housing 310 may be higher than the internal atmospheric pressure of the chamber housing 310 in the first transfer mode performing step S430. For example, an output of the vacuum pump 740 in the second transfer mode performing step S450 may be lower than an output of the vacuum pump 740 in the first transfer mode performing step S430.

As a difference between the internal atmospheric pressure of the chamber housing 310 and the external atmospheric pressure decreases, the amount of powder flowing into the chamber housing 310 per hour may decrease. As a result, the amount of powder flowing into the chamber housing 310 can be more precisely controlled.

In the step S450, at least a portion of the powder accommodated in the container 100 may sequentially pass through the container pipe 410 and the chamber pipe 430 and be transferred to the inside of the chamber housing 310. When the second transfer mode performing step S450 is completed, the coupling valve 560 may be opened. When the coupling valve 560 is opened, the powder accommodated in the chamber housing 310 may be transferred to the inside of the hopper body 210.

The first reference powder amount and the second reference powder amount may be positive real numbers. The second reference powder amount may be greater than the first reference powder amount. The second reference powder amount may indicate an amount or powder to be transferred to the inside of the hopper body 210 among the powder stored in the container 100.

For another example, in the process of transferring the powder stored in the container 100 to the inside of the hopper body 210, it may be necessary to omit the first transfer mode and transfer the powder in the second transfer mode. In this case, the first reference powder amount may be set to a real number less than or equal to zero.

Only specific examples of implementations of certain embodiments are described. Variations, improvements and enhancements of the disclosed embodiments and other embodiments may be made based on the disclosure of this patent document.

What is claimed is:

1. A powder feeding device comprising:
a container including a container body forming a storage space inside the container body;
a hopper including a hopper body forming an accommodation space inside the hopper body;
a chamber unit including a chamber housing, the chamber housing forming a hollow portion and coupled to the hopper body;
a pipe assembly including:
a container pipe unit which extends from the container and is opened or closed;
a hopper pipe unit which is branched from the container pipe unit, is connected to the hopper body, and is opened or closed; and
a chamber pipe unit which is branched from the container pipe unit, is connected to the chamber housing, and is opened or closed; and
a valve assembly including a coupling valve which is coupled to at least one of the chamber housing and the hopper body and connects or disconnects the storage space with the hollow portion.

2. The powder feeding device of claim 1, wherein the valve assembly further includes:
a container valve coupled to the container pipe unit, the container valve opening or closing the container pipe unit;
a hopper valve coupled to the hopper pipe unit, the hopper valve opening or closing the hopper pipe unit; and
a chamber valve coupled to the chamber pipe unit, the chamber valve opening or closing the chamber pipe unit.

3. The powder feeding device of claim 1, wherein the chamber unit further includes a chamber port extending from the chamber housing, and
wherein the pipe assembly further includes a pump pipe, and an end of the pump pipe extends from the chamber port and another end of the pump pipe leads to a vacuum pump.

4. The powder feeding device of claim 3, wherein the valve assembly further includes a vacuum line valve coupled to the pump pipe, the vacuum line valve opening or closing the pump pipe.

5. The powder feeding device of claim 4, wherein the valve assembly further includes a vacuum release valve coupled to the chamber port, the vacuum release valve opening or closing the chamber port.

6. The powder feeding device of claim 5, wherein the end of the pump pipe is located between the vacuum release valve and the chamber housing.

7. The powder feeding device of claim 5, wherein the chamber unit further includes a chamber filter which is located in the hollow portion of the chamber housing and performs a filter function.

8. The powder feeding device of claim 7, wherein the chamber unit further includes a chamber blower spraying a gas into the chamber filter.

9. The powder feeding device of claim 8, further comprising:
a pressure sensor measuring an internal atmospheric pressure of the chamber housing; and
a control unit connected to the pressure sensor and receiving a second signal from the pressure sensor,
wherein the control unit operates the chamber blower when the internal atmospheric pressure of the chamber housing from the second signal is greater than or equal to a reference chamber internal pressure.

10. The powder feeding device of claim 1, further comprising a vacuum pump and a vacuum filter unit,
wherein the pipe assembly further includes a pump pipe, and an end of the pump pipe extends from the chamber unit and another end of the pump pipe leads to the vacuum pump, and
wherein the vacuum filter unit includes:
a vacuum filter housing coupled to the pump pipe; and
a vacuum filter located in the vacuum filter housing.

11. The powder feeding device of claim 1, further comprising:
a weight sensor connected to the hopper body and measuring a weight applied to the weight sensor; and
a control unit connected to the weight sensor and receiving a second signal from the weight sensor,
wherein the control unit opens the container pipe unit and the hopper pipe unit and closes the chamber pipe unit when an increase amount of a weight measured by the weight sensor from the second signal is less than or equal to a first reference powder amount.

12. The powder feeding device of claim 11, wherein the control unit opens the container pipe unit and the chamber pipe unit and closes the hopper pipe unit when the increase amount of the weight from the second signal is greater than or equal to the first reference powder amount and is less than a second reference powder amount.

13. A powder transfer method of transferring a powder stored in a container to one of a hopper and a chamber unit, the powder transfer method comprising:
measuring an internal pressure of a chamber housing included in the chamber unit;
comparing the measured internal pressure with a reference chamber internal pressure; and
spraying a gas into a chamber filter included in the chamber housing when the measured internal pressure is greater than or equal to the reference chamber internal pressure, or transferring the powder stored in the container to one of the hopper and the chamber unit when the measured internal pressure is less than the reference chamber internal pressure,
wherein transferring the powder is performed in parallel with measuring the internal pressure.

14. The powder transfer method of claim 13, wherein spraying the gas into the chamber filter comprises:
determining whether a transfer mode is a first transfer mode;
performing a first blowing mode when the transfer mode is the first transfer mode; and
performing a second blowing mode when the transfer mode is not the first transfer mode.

15. The powder transfer method of claim 14, wherein when an amount of the powder introduced into the hopper and the chamber unit is less than a first reference powder amount, the transfer mode is the first transfer mode, and
wherein when the amount of the powder introduced into the hopper and the chamber unit is greater than or equal to the first reference powder amount and is less than a second reference powder amount, the transfer mode is a second transfer mode.

16. The powder transfer method of claim 14, wherein performing the first blowing mode comprises:
performing a first pre-blowing process of blocking the hopper and the container from communicating with the chamber housing and exposing the chamber housing to an outside air;
spraying the gas into the chamber filter; and
performing a first post-blowing process of blocking the chamber housing from the outside air and communicating the chamber housing with the hopper and the container.

17. The powder transfer method of claim 14, wherein performing the second blowing mode comprises:
performing a second pre-blowing process of blocking the hopper and the container from communicating with the chamber housing and exposing the chamber housing to an outside air;
spraying the gas into the chamber filter; and
performing a second post-blowing process of blocking the chamber housing from the outside air and communicating the chamber housing with the container.

18. The powder transfer method of claim 13, wherein transferring the powder comprises:
measuring an amount of the powder introduced into the hopper and the chamber unit;
comparing the measured amount of the powder with a first reference powder amount; and
performing a first transfer mode when the measured amount of the powder is less than the first reference powder amount.

19. The powder transfer method of claim 18, wherein transferring the powder comprises:
comparing the measured amount of the powder with a second reference powder amount when the measured amount of the powder is greater than or equal to the first reference powder amount; and
performing a second transfer mode when the measured amount of the powder is less than the second reference powder amount,
wherein in performing the first transfer mode, the powder stored in the container is transferred to the hopper, and
wherein in performing the second transfer mode, the powder stored in the container is transferred to the chamber housing,

20. The powder transfer method of claim 19, wherein performing the first transfer mode is performed in parallel with measuring the amount of the powder, and
wherein performing the second transfer mode is performed in parallel with measuring the amount of the powder.
